(19) United States
(12) Patent Application Publication
(10) Pub. No.: US 2010/0274548 A1
(43) Pub. Date: Oct. 28, 2010

(54) Clock Approximation for Hardware Simulation

(76) Inventors: Du Nguyen, Tigard, OR (US); Anissa Mawer, Folsom, CA (US)

Correspondence Address: MENTOR GRAPHICS CORP.;PATENT GROUP, 8005 SW BOECKMAN ROAD, WILSONVILLE, OR, 97070-7777, US

(21) Appl. No.: 12/697,290

(22) Filed: Jan. 31, 2010

Related U.S. Application Data
(60) Provisional application No. 61/173,429, filed on Apr. 28, 2009.

(51) Int. Cl. G06F 17/50

(52) U.S. Cl. 703/14

(57) ABSTRACT

Clock approximate signals within an electronic design may be identified. Allowing the identified clock approximate signals to be conditionally ignored during a subsequent simulation of the electronic design may provide for a significant increase in the efficiency of the simulation.

### RELATED APPLICATIONS

This application claims priority to U.S. Provisional Patent Application No. 61/173,429, entitled “Clock Approximation for Hardware Simulation,” filed on Apr. 28, 2009, and naming Du Nguyen et al. as inventor, which application is incorporated entirely herein by reference.

### FIELD OF THE INVENTION

The present invention relates to the field of hardware simulation.

### BACKGROUND OF THE INVENTION

Electronic circuits, such as integrated microcircuits, are used in a variety of products, from automobiles to microwaves to personal computers. Designing and fabricating microcircuit devices typically involves many steps, sometimes referred to as the “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators. These steps aid in the discovery of errors in the design, and allow the designers and engineers to correct or otherwise improve the design. These various microcircuits are often referred to as integrated circuits (IC's).

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit.

After the accuracy of the logical design is confirmed, it is converted into a device design by synthesis software. The device design, which is typically in the form of a schematic or netlist, describes the specific elements (such as transistors, resistors, and capacitors) that will be used in the circuit, along with their interconnections. This device design generally corresponds to the level of representation displayed in conventional circuit diagrams. The relationships between the electronic devices are then analyzed, often mathematically, to confirm that the circuit described by the device design will correctly perform the desired functions. This analysis is sometimes referred to as “formal verification.” This verification may be facilitated by a simulation process. Additionally, timing verifications are often made at this stage, to ensure that the device is capable of operating as the speeds intended, for example by ensuring proper setup and hold times of the signals within the design.

Once the components and their interconnections are established, the design is again transformed, this time into a physical design that describes specific geometric elements. This type of design often is referred to as a “layout” design. The geometric elements, which typically are polygons, define the shapes that will be created in various layers of material to manufacture the circuit. Typically, a designer will select groups of geometric elements representing circuit device components (e.g., contacts, channels, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools) are commonly used for both of these tasks.

### Electronic Design Verification

As stated, electronic devices are often verified during design development, for example to ensure compliance with the intended design specification. Design simulation has traditionally been the preferred means for validating an electronic design, particularly integrated circuits. Simulation usually entails analyzing the circuit response to a set of input stimuli over a certain time interval. Simulation can be performed at different levels of abstraction as briefly introduced above. At the geometrical level of abstraction, circuits can be modeled as an interconnection of electronic devices (e.g., transistors) and parasitic (e.g., resistance and capacitance). Circuit-level simulation corresponds to deriving the voltage levels at certain circuit nodes as a function of time. Logic-level simulation is the analysis of the functionality of a circuit in terms of logic variables. Functional level simulation corresponds to simulating HDL or other models of digital circuits.

Designers can simulate a model of a circuit under development together with models of other previously designed (or off-the-shelf) circuits. In other words, simulation allows a designer to validate a circuit in its environment. While there have been various breakthroughs in simulation technology over the years, simulators usually operate with a great number of inefficiencies. For example, hardware simulators routinely execute the evaluation of many elements whose outputs are not going to change for a certain period of time. This unnecessary evaluation results in the waste of large amounts of processing time. Furthermore, in large designs, the mere accessing or updating of information about a cell that does not need to be re-evaluated can cause memory cache misses. This also results in the waste of large amounts of processing time.

As those of skill in the art can appreciate, some elements in a typical electronic design, particularly data storage elements, have input and output signals that govern the behavior of the element. These input and output signals are often referred to as “clocks.” In the context of data storage elements, these clock signals govern the timing of when data is captured from the various input signals. For example, some data storage elements capture the logic value on the input signal line and output the captured logic value when the clock signal changes or “toggles.” Accordingly, if the logic value or “data” on the input signal lines does not change neither will the output data signals, even if the clock signal toggles. As a result, some changes in the clock signal will not result in a change in the data on the output signal lines.

### BRIEF SUMMARY OF THE INVENTION

Various illustrative implementations of the invention provide methods and related apparatus to identify signals within a design that may be conditionally ignored during a simulation in order to increase the efficiency of the simulation. More particularly, various implementations of the invention provide for the identification of signals whose state changes may be ignored if the logic values of the interconnected elements are not changing. These signals to be ignored are herein referred to as “clock approximates” or “clock approximate signals.” In some implementations, high-frequency nets are identified as clock approximates. With some implementations, high-frequency, high-fanout nets are identified as clock approximates.

In various implementations, clock approximates within an electronic design are identified based upon timing checks implemented on the electronic design. Clock approximates may be identified based on selected timing checks, such as hold and setup-hold timing checks, for example, by identifying the conditional signals in the timing check.

With various implementations, clock approximates within an electronic design are identified based upon modeling constructs of the hardware elements. For example, in some illustrative implementations, sequential operations described by the modeling constructs are first identified. Subsequently, the signals treated as edge triggers in the modeling constructs and which are not “read in” during the sequential operation are identified as the clock approximates.

With further implementations, a set of clock approximates may be identified from a set of potential clock approximates. Potential clock approximates may be identified by the above introduced methods for example. Subsequently, a portion of a simulation process is implemented on the electronic design. Clock approximates are then identified based upon the portion of the simulation process.

### BRIEF DESCRIPTION OF THE DRAWINGS

The present invention will be described by way of illustrative embodiments shown in the accompanying drawings in which like references denote similar elements, and in which:

FIG. 1 shows an illustrative computing environment;

FIG. 2 shows an illustrative arrangement of elements in an electronic design;

FIG. 3 shows an illustrative megacell of hardware elements;

FIG. 4 illustrates a static method for identifying clock approximates;

FIG. 5 shows an illustrative netlist;

FIG. 6 illustrates a method of identifying clock approximates based upon timing checks;

FIG. 7 illustrates a method for identifying clock approximates based upon modeling constructs;

FIG. 8 illustrates a dynamic method for identifying clock approximates;

FIG. 9 illustrates an additional dynamic method for identifying clock approximates; and

FIG. 10 illustrates a clock approximate identification tool.

### DETAILED DESCRIPTION OF ILLUSTRATIVE EMBODIMENTS

Although the operations of the disclosed implementations may be described herein in a particular sequential order, it should be understood that this manner of description encompasses rearrangements, unless a particular ordering is required by specific language set forth below. For example, operations described sequentially may in some cases be rearranged or performed concurrently. Moreover, for the sake of simplicity, the illustrated flow charts and block diagrams typically do not show the various ways in which particular methods can be used in conjunction with other methods. Additionally, the detailed description sometimes uses terms like “determine” or “identify” to describe the disclosed methods. Such terms are often high-level abstractions of the actual operations that are performed. The actual operations that correspond to these terms will vary depending on the particular implementation and are readily discernible by one of ordinary skill in the art.

The disclosed implementations can, for example, be applied to a wide variety of integrated circuits, including sequential integrated circuits. A sequential integrated circuit (or sequential circuit) is one whose outputs depend not only on its current inputs, but also on the past sequence of inputs, possibly arbitrarily far back in time. Examples of sequential circuits include programmable logic devices (PLDs) such as field programmable gate arrays (FPGAs), application-specific integrated circuits (ASICs), and systems-on-a-chip (SoCs). A sequential circuit contains at least one sequential circuit element, such as a flip-flop, a synchronous RAM element, or a latch. A sequential circuit element (or sequential element) generally refers to any circuit element whose outputs state changes occur at times specified by a free-running clock signal.

Some of the methods described herein can be implemented by software stored on a computer readable storage medium, or executed on a computer. Additionally, some of the disclosed methods may be implemented as part of a computer implemented electronic design automation (EDA) tool. The selected methods could be executed on a single computer or a computer networked with another computer or computers. For clarity, only those aspects of the software germane to these disclosed methods are described; product details well known in the art are omitted.

### Illustrative Computing Environment

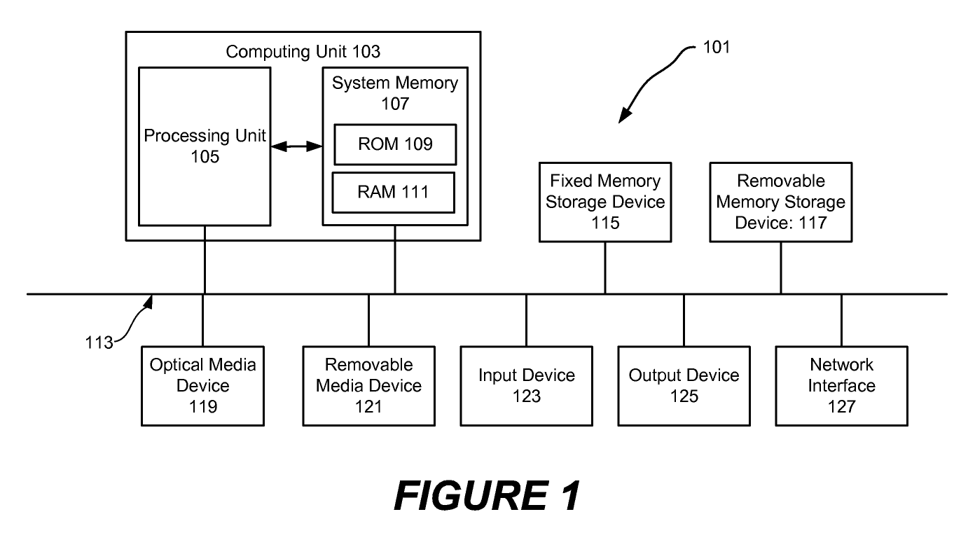

A computing environment suitable for implementing the invention is described herein. However, as indicated above, other computing environments not described herein may also be suitable for implementation of the invention. FIG. 1 shows an illustrative computing device 101. As seen in this figure, the computing device 101 includes a computing unit 103 having a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional devices; such as, a fixed memory storage device 115 (e.g., a magnetic disk drive;) a removable memory storage device 117 (e.g., a removable solid state disk drive;) an optical media device 119 (e.g., a digital video disk drive;) or a removable media device 121 (e.g., a removable floppy drive.) The processing unit 105 and the system memory 107 also may be directly or indirectly connected to one or more input devices 123 and one or more output devices 125. The input devices 123 may include, for example, a keyboard, a pointing device (e.g., a mouse, touchpad, stylus, trackball, or joystick), a scanner, a camera, and a microphone. The output devices 125 may include, for example, a monitor display, a printer and speakers. With various examples of the computing device 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) and the Internet protocol (IP). Also, the interface 127 may employ any suitable connection agent (or combination of agents) for connecting to a network, including, for example, a wireless transceiver, a modem, or an Ethernet connection.

Various embodiments of the invention may be implemented using one or more computers that include the components of the computing device 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

### Simulation Optimization

In the present application, the terms “element” or “elements,” and “hardware element,” or “hardware elements” are used throughout. Such terms can represent various components of an electronic design. For example, a transistor, a flip-flop, a latch, or a memory cell, are all examples of an element. These elements are in turn connected conductive traces or “signal carriers” that allow for the transmission of logic values or “data” between the elements. For convenience, these conductive traces are often referred to simply as signals. As stated above, various implementations of the invention provide for the identification of signals that may be conditionally ignored during a simulation, in order to increase the simulation efficiency. This will be further explained below.

During simulation, designs often have certain properties that can be taken advantage of to eliminate unnecessary evaluations and increase the efficiency of the simulation. For example, there are often input signals, such as, for example, a clock, which are inputs to elements within a design whose data (or non-clock) input changes with a much lower frequency than does the clock input. In such circuits, once a data input change has been clocked to the output of an element, the output will usually not change again until there is a non-clock input change. Thus, there can be many changes in the clock input that will not cause a change in the output of the cell. It is therefore desirable to ignore (e.g., not take processing time to evaluate) each change of the high frequency signal, elements having internal states and outputs that do not change with the change of the high frequency signal. Ignoring such elements generally results in the speeding up of the simulation. Such an increase in simulation efficiency is usually dramatic.

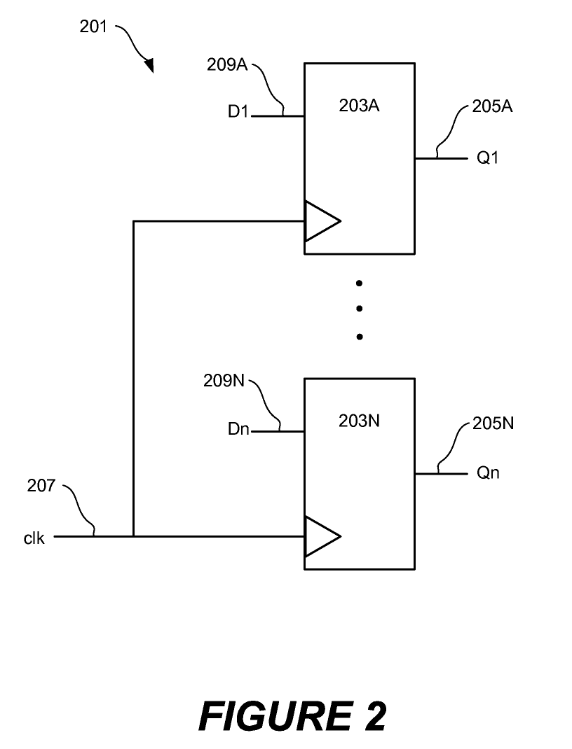

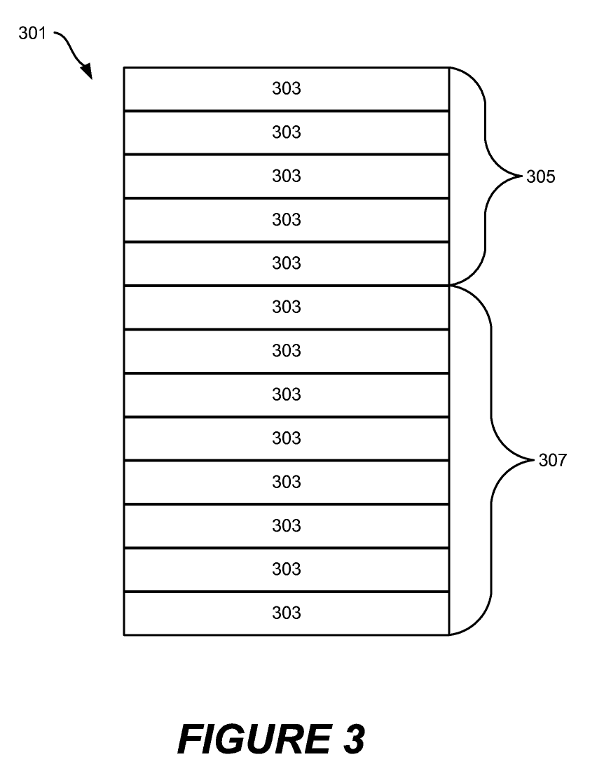

Ignoring these elements may be facilitated by treating elements to be ignored as “inactive” while treating elements to be processed or evaluated in the simulation as “active.” Accordingly, simulation results for active elements would be processed differently than for inactive elements. For example, such processing can include updating simulation results from active elements while not updating simulation results from inactive elements. Alternatively, such processing can include storing simulation results from active elements which not storing simulation results from inactive elements. In yet another alternative, such processing can include replaying simulation results from active elements which not replaying simulation results from inactive elements. This concept will be further explained with reference to FIG. 2 and FIG. 3.

FIG. 2 illustrates a hardware configuration 201. As can be seen from this figure, the hardware configuration 201 is comprised of an arrangement of elements 203A-203N. Each element 203 in this example has two input signals and one output signal (Q1-Qn) 205A-205N. One input signal is a clock (clk) 207 signal. The second input signal (D1-Dn) 209A-205N is a non-clock signal that usually changes much less frequently than the clock signal. The following code can be used in connection with an example simulation of the hardware configuration 201:

```
module Dff( D, clk, Q);
      input D;
      input clk;
      output Q;
      reg Q_reg = 2′b0;
      assign Q = Q_reg;
      always @ (posedge elk) being
            Q_reg = D;
      end
endmodule
```

To better optimize the efficiency of simulations, such as, for example, a simulation implemented on the hardware configuration 201, the always statement can be modified or eliminated. This would allow hardware elements to not be evaluated until a non-clock input signal, such as, for example, one of the second input signals 209, changes. More particularly, a hardware element will be treated as inactive even when the clock approximate signals connected to the hardware element are changing state. However, once a non-clock approximate signal changes state, the hardware element will be classified as active and processed in the simulation. This may be facilitated by grouping the hardware elements into “megacells.”

FIG. 3 shows a block diagram of an exemplary megacell 301. As can be seen from this figure, the megacell 301 includes an array of pointers 303. The pointers 303 reference a hardware element or a group of hardware elements, of which at least one hardware element is connected to at least one clock approximate. For example, one of the array pointers 303 may reference one of the hardware elements 203 of FIG. 2. Alternatively, one of the array pointers 303 may reference all of the hardware elements 203 of FIG. 2.

During the simulation, the megacell 301 can be partitioned, such as into a first sub-array 305 and a second sub-array 307. These sub-arrays 305 and 307 may be the only two sub-arrays or they may comprise a grouping of plural sub-arrays. One sub-array (e.g., 305) can track cells that are deemed active. Another sub-array (e.g., 307) can track cells that are deemed inactive. Again, more than one sub-array may be used for each of these purposes. Furthermore, various implementations may comprise more than one such megacell. For example, an implementation may comprise one megacell for positive-edge (posedge) clock transitions and another megacell for negative-edge (negedge) clock transitions. Other megacells may also be used for cells that can be grouped as inactive or active depending upon their response to a common input (e.g., one megacell for data elements triggered by signals from a first clock and another megacell for data elements triggered by a separate clock).

When a clock approximate signal (e.g., the clk signal 207 of FIG. 2 above) changes value between 1 and 0, only a sub-array(s) tracking active cells (e.g., sub-array 305 of FIG. 3) are accessed. Inactive cells can usually be ignored, which means that the subarray(s) tracking inactive cells (e.g., sub-array 307) need not be considered at this point. Sub-arrays may be moved from active to inactive classification and vice versa. For example, as stated above, when a non-clock approximate signal changes value between 1 and 0, the array pointer 303 referencing that hardware element may be classified as active, if it is not already.

### Static Clock Approximate Identification

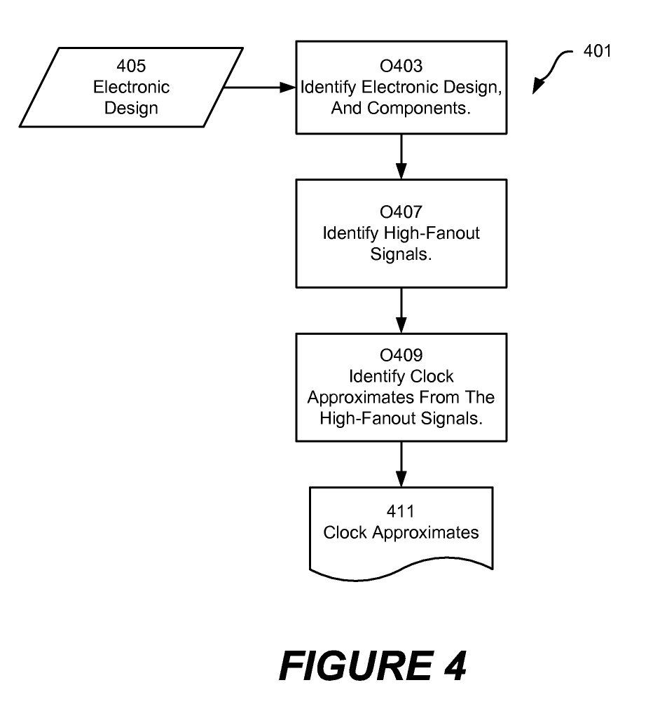

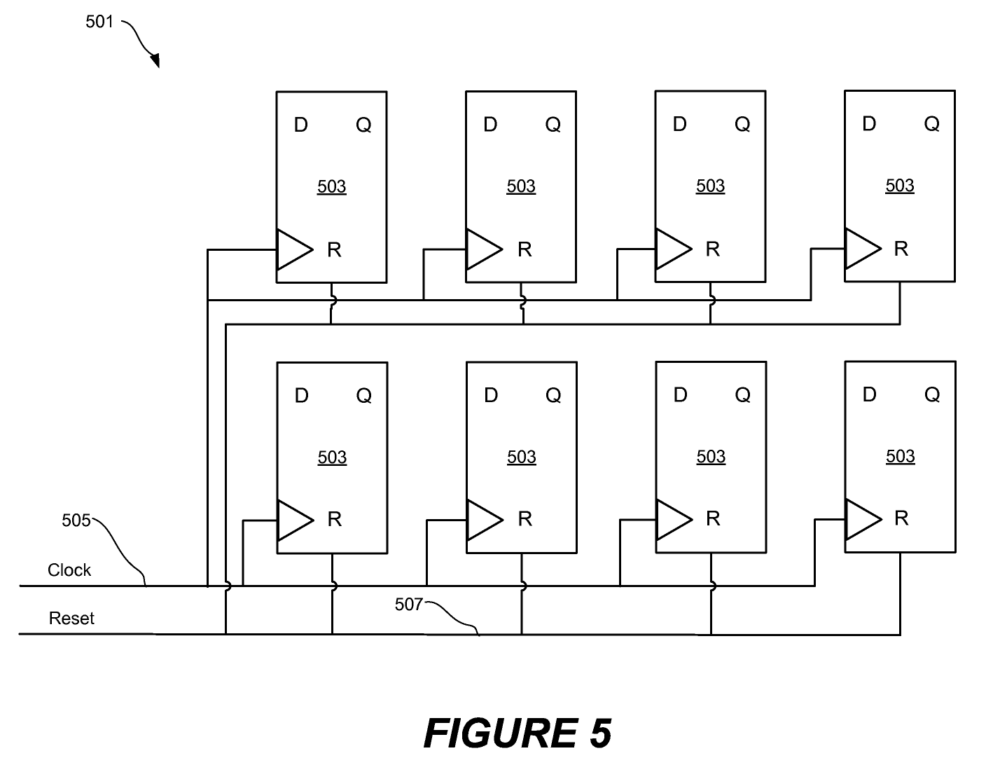

FIG. 4 illustrates a method 401 for identifying clock approximates in an electronic design. As can be seen from this figure, the method 401 includes an operation 403 for identifying an electronic design 405. Followed by an operation 407 for identifying high-fanout signal within the electronic design 405. Subsequently, an operation 409 for identifying clock approximates 411 from the high-fanout signal is provided. An illustrative application of the method 401 will be explained with reference to FIG. 5.

As described above, clock approximates may conceptually be described as high-frequency, high-fanout nets in circuits and in digital simulation of such circuits. FIG. 5 illustrates a netlist 501 having hardware elements 503. As can be seen from this figure, the hardware elements 503 are D type flip flops, having a clock signal 505 and a reset signal 507, as well as an input signal (D) and an output signal (Q).

As can be appreciated, fanout refers to the number of downstream elements that a particular element is able to “drive,” or alternatively, the number of elements which a signal is driving. More particularly, as can be seen from FIG. 5, the reset signal 507 is connected to all eight elements 503. Accordingly, the fanout of the reset signal 507 is eight. As can be additionally, seen, the fanout for the reset signal 507 as well as the clock signal 505 is higher than the fanout for the other input signals (D) and output signals (Q) within the netlist 501.

In various implementations, the operation 407 identifies signals as high-fanout if the signal has a fanout higher than a preselected threshold fanout. For example, if the threshold fanout were five, the operation 407 would identify both the clock signal 505 and the reset signal 507 as high-fanout. With some implementations, the operation 407 identifies signals that have the highest fanout relative to all signals in the design as the high-fanout signals.

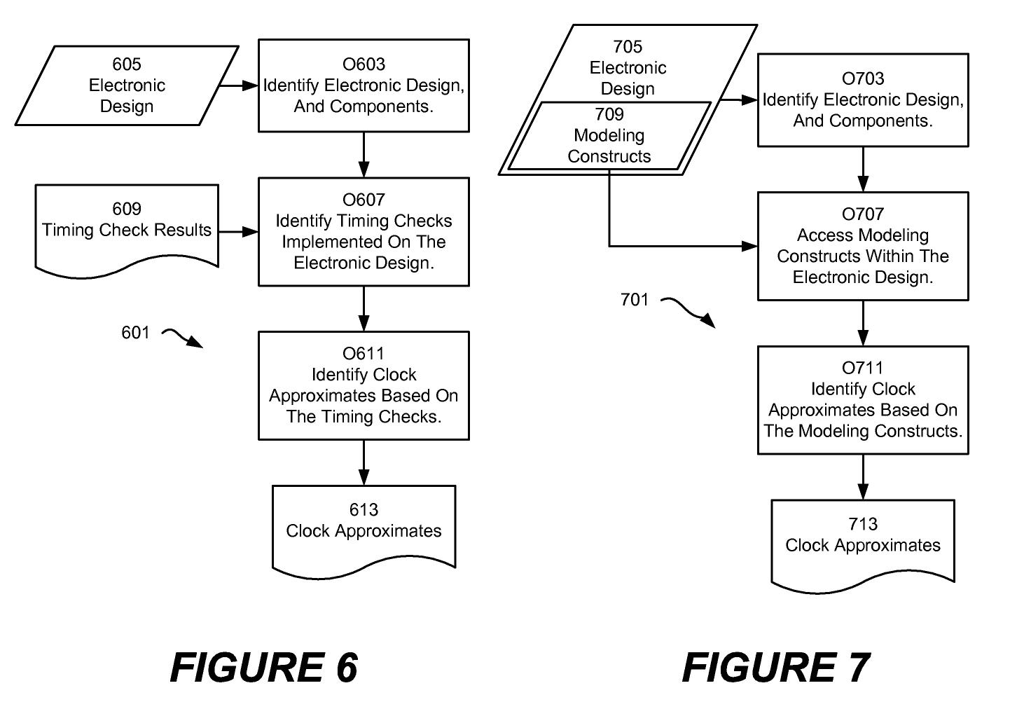

In various implementations, the operation 409 identifies as clock approximates 411 all the signals identified by the operation 407. With some implementations, the operation 409 identifies a portion of the high-fanout signals as clock approximates 411. FIG. 6 illustrates a method 601 for identifying clock approximates. In various implementations, the operation 409 implements the method 601 to identify clock approximates from the high-fanout signals. With some implementations, the method 601 is implemented outside of the method 401, to identify clock approximates from all signals within a design. As can be seen from FIG. 6, the method 601 includes an operation 603 for identifying an electronic design 605. Followed by an operation 607 for identifying timing checks 609, which have been implemented on the electronic design 605. Subsequently, an operation 611 for identifying clock approximates 613 from the electronic design 605 based upon the timing checks 609 is provided.

The following pseudo code may be used to identifying a clock approximate (i.e. TheClock) based upon a timing check (e.g., like the method 601):

```
set TheClock = NULL
for (each timing check)
      if (timing check kind == kind hold or timing check
      kind == kind setup-hold)
            set clock1 = signal1
            set clock2 = signal2
            if (TheClock == NULL or TheClock == clock2)
                  set TheClock = clock1
            end
      end
end
```

As those of skill in the art can appreciate, a hold timing check ensures that once a clock signal has changed logical value, such as, for example from a 0 to a 1, the data signal (e.g., D in FIG. 5) does not change values for a specified amount of time. Often referred to as the hold time. This ensures that the output (e.g., Q in FIG. 5) will reflect the logical value of the input at the time the clock changed values. The type of check is utilized to determine clock like signals as described above.

FIG. 7 illustrates a method 701 that may be provided by various implementations of the invention to determine clock approximates within an electronic design. With some implementations, the operation 409 implements the method 701 to identify clock approximates from high-fanout signals. With alternative implementations, the method 701 is implemented to identify clock approximates form all signals within a design. In some implementations, both the methods 601 and 701 may be implemented by the operation 409. Alternatively, both the method 601 and 701 may be implemented on the same design to identify clock approximates from all signals within the design.

As can be seen from FIG. 7, the method 701 includes an operation 703 for identifying an electronic design 705 and an operation 707 for identifying modeling constructs 709 from within the electronic design 705. In various implementations, the modeling constructs are “stored” in the hardware elements. More particularly as those of skill in the art can appreciate, hardware elements are often described by a hardware description language, such as, for example Verilog. Modeling constructs may be included in this hardware description of the element. For example, the following Verilog code is a modeling construct:

```
always @ (posedge clk or negedge resetn) begin
      if (resetn == 0)
            Q_reg = 0;
      else
            Q_reg = D;
end
```

Returning to FIG. 7, the method 701 further includes an operation 711 for identifying clock approximates 713 from the modeling constructs 709. In various implementations, the clock approximates 713 are those signals in the modeling constructs 709 that are edge triggers, but are not “read in” during the process. For example, referring to the Verilog code above, the clk and resetn signals are edge triggers, but they are not read in during any of the sequential processes in the modeling construct.

### Dynamic Clock Approximate Identification

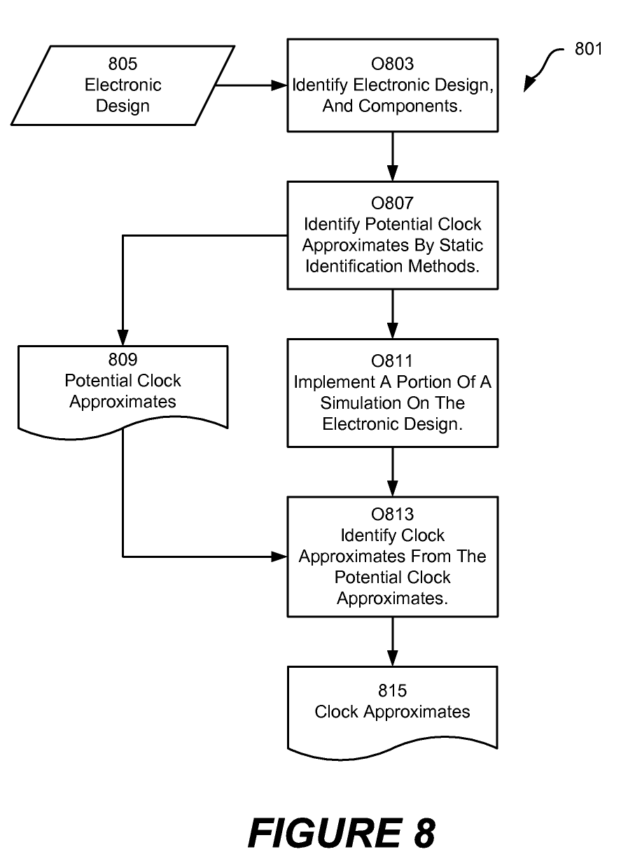

In various implementations of the invention, following a static identification of clock approximates, such as for example by application of any of the methods 401, 601, or 701, the identified clock approximates may be further refined by dynamic methods. For example, FIG. 8 illustrates a method 801 for dynamically determining clock approximates. As can be seen from this figure, the method 801 includes an operation 803 for identifying an electronic design 805. Subsequently, the method 801 includes an operation 807 for identifying potential clock approximates via static identification methods. In various implementations, the operation 807 performs the method 401 of FIG. 4. With further implementations, the operation 807 performs both the methods 601 of FIG. 6 and the method 701 of FIG. 7. Still, with some implementations, the operation 807 performs either of the methods 601 of FIG. 6 or the method 701 of FIG. 7.

The method 801 further includes an operation 811 for implementing a portion of a simulation on the electronic design 805. The operation 811 “monitors” the potential clock approximate signals 809 during the simulation. For example, in various implementations, the operation 811 may implement the simulation and monitor the frequency of the potential clock approximate signals 809. With some implementations, the operation 811 may implement the simulation and monitor frequency of the potential clock approximates relative to the non-clock approximates. For example, returning to FIG. 5, assuming that both the clock signal 505 and the reset signal 507 were identified as clock approximates 809, the signal with the highest frequency during the simulation implemented by the operation 811 may be identified by the operation 813 as the clock approximate 815. In alternative implementations, the signal which reaches the first number of events, or which is first to change state a preselected number of times, may be identified by the operation 813 as the clock approximate 815.

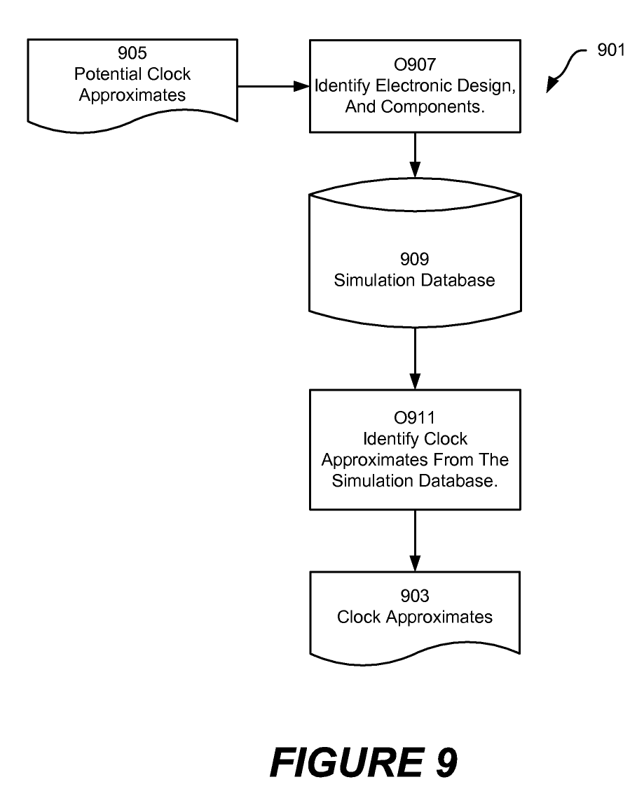

FIG. 9 illustrates a method 901 that may be provide by various implementations of the invention to identify clock approximates 903 from potential clock approximates 905. The method 901 includes an operation 907 for implementing a portion of a simulation process on the electronic design (e.g., the electronic design 405) corresponding to the potential clock approximates 905. As can be seen from this figure, the operation 907 generates a database 909 of simulation metrics. In various implementations, the database 909 includes the frequency of the potential clock approximates 905 and, or in the alternative, the number of times the potential clock approximates 905 changed state.

The method 901 further includes an operation 911 for identifying the clock approximates 903 from the simulation database 909. In various implementations, the operation 911 identifies the potential clock approximates 905 that changed state a preselected number of times first as the clock approximates 903. In alternative implementations, the operation 911 identifies the potential clock approximates 905 with the highest frequency as the clock approximates 903.

### Clock Approximate Identification Tool

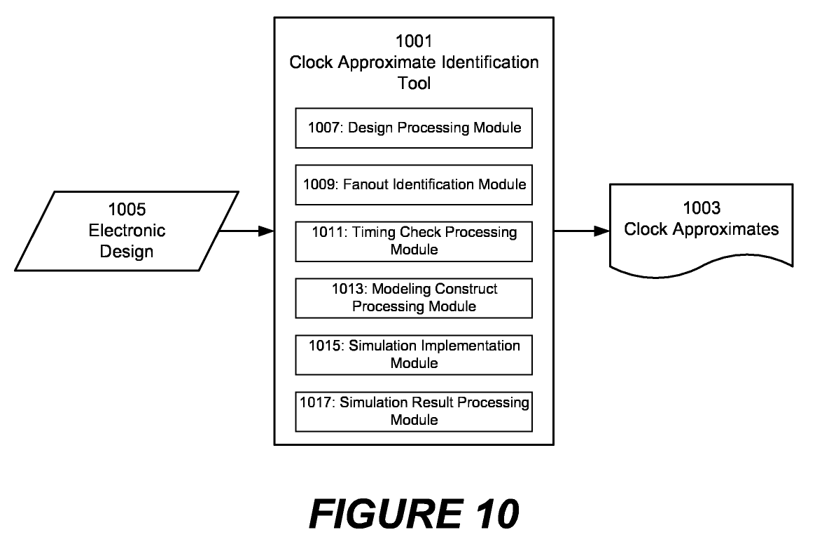

FIG. 10 illustrates a clock approximate identification tool 1001, which may be configured to implement the methods described above. As can be seen from this figure, the tool 1001 is configured to generate a list of clock approximates 1003 from an electronic design 1005. The tool 1001 includes a design processing module 1007 (e.g., for identifying and processing the netlist or code describing the design), a fanout identification module 1009 (e.g., for identifying the high-fanout signals), a timing check processing module 1011 (e.g., for performing the method 601 of FIG. 6), a modeling construct processing module 1013 (e.g., for performing the method 701 of FIG. 7), a simulation implementation module 1015 (e.g., for implementing a portion of a simulation on the electronic design 1005), and simulation result processing module 1017 (e.g., for identifying clock approximates based upon the simulation).

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

1. A computer-implemented method for determining one or more clock approximate signals within an electronic design comprising:
identifying an electronic design, the electronic design including a plurality of hardware models interconnected by a plurality of signal carriers;
identifying one or more timing checks, the one or more timing checks having been implemented on the electronic design; and
identifying a clock approximate from the plurality of signal carriers based in part upon the one or more timing checks.

2. The computer-implemented method recited in claim 1, wherein each of the one or more timing checks include a result, the result identifying a first one of the plurality of signal carriers and a second one of the plurality of signal carriers, and the method act of identifying a clock approximate from the plurality of signal carriers based in part upon the one or more timing checks comprising:
identifying a type corresponding to each of the one or more timing checks; and
for each of the one or more timing checks,
designating the first one of the plurality of signals as the clock approximate if the type is a preselected type and the clock approximate is equivalent to either a null value or the second one of the plurality of signals.

3. The computer-implemented method recited in claim 2, the preselected type being either a hold type timing check or a setup-hold type timing check.

4. The computer-implemented method recited in claim 3, wherein:
one or more of the hardware models include a modeling construct, the one or more modeling constructs describing one or more operations to be performed on data carried by ones of the plurality of signal carriers connected to the respective hardware model; and
the method further comprises identifying one or more additional clock approximates from the plurality of signal carriers based in part upon the one or more modeling constructs.

5. The computer-implemented method recited in claim 4, the method act for identifying one or more additional clock approximates from the plurality of signal carriers based in part upon the one or more modeling constructs comprising:
for each of the one or more modeling constructs that describe sequential operations,
identifying ones of the plurality of signal carries connected to the respective hardware model that are edge trigger, and
designating the identified ones of the plurality of signal carriers that are edge triggers and that are not read in during the sequential operations as ones of the one or more additional clock approximates.

6. The computer-implemented method recited in claim 5, further comprising:
designating the clock approximate and the one or more additional clock approximates as a plurality of potential clock approximates;
implementing a portion of a simulation process on the electronic design; and
identifying the clock approximate from the plurality of potential clock approximates based in part upon the portion of the simulation process.

7. The computer-implemented method recited in claim 6, the method act for identifying one or more clock approximates from the plurality of potential clock approximates based in part upon the portion of the simulation process comprising:
identifying the one of the plurality of potential clock approximates that changed state the most highest number of times during the portion of the simulation process; and
designating the identified one of the plurality of potential clock approximates as the clock approximate.

8. A computer-implemented method for determining at least one clock approximate within an electronic design comprising:
identifying an electronic design, the electronic design including a plurality of hardware models interconnected by a plurality of signal carriers;
identifying ones of the plurality of signal carriers that are high-fanout;
implementing at least a portion of a simulation process on the electronic design;
identifying one or more clock approximates from the ones of the plurality signal carriers that are high-fanout based in part upon the portion of the simulation process.

9. The computer-implemented method recited in claim 8, the method act for identifying one or more clock approximates from the ones of the plurality signal carriers that are high-fanout comprising:
identifying a threshold fanout value; and
designating the ones of the signal carriers that drive a number of the plurality of hardware elements greater than the threshold fanout value as high-fanout.

10. The computer-implemented method recited in claim 9, the method act for identifying a threshold fanout value comprises:
deriving the fanout for each of the plurality of signal carriers; and
deriving the average of the derived fanouts; and
designating the threshold value as greater than the derived average but less than the highest the derived fanouts.

11. The computer-implemented method recited in claim 10, the method act for implementing at least a portion of a simulation process on the electronic design comprising:
initiating the simulation process;
tracking the frequency with which the plurality of high-fanout signal carriers change state; and
terminating the simulation process.

12. The computer-implemented method recited in claim 11, the method act for identifying a clock approximate from the ones of the plurality signal carriers that are high-fanout based in part upon the portion of the simulation process comprising:
identifying the one of the plurality of high-fanout signal carriers that changed state the most number of times during the portion of the simulation process; and
designating the identified one of the plurality of high-fanout signal carriers as the clock approximate.

13. The computer-implemented method recited in claim 11, the method act for terminating the simulation process terminates the simulation process when a one of the high-fanout signal carriers has changed state a preselected number of times.

14. The computer-implemented method recited in claim 13, wherein the target frequency is 1000.

15. The computer-implemented method recited in claim 9, wherein the threshold fanout value is greater than 5.

16. One or more tangible computer-readable media, having computer executable instructions for determining one or more clock approximate signals within an electronic design stored thereon, the computer executable instructions comprising:
causing a computer to perform a set of operations; and
wherein the set of operations include:
identifying an electronic design, the electronic design including a plurality of hardware models interconnected by a plurality of signal carriers;
identifying one or more timing checks, the one or more timing checks having been implemented on the electronic design; and
identifying a clock approximate from the plurality of signal carriers based in part upon the one or more timing checks.

17. The one or more tangible computer-readable media recited in claim 16, wherein each of the one or more timing checks include a result, the result identifying a first one of the plurality of signal carriers and a second one of the plurality of signal carriers, and the operation for identifying a clock approximate from the plurality of signal carriers based in part upon the one or more timing checks comprises:
identifying a type corresponding to each of the one or more timing checks; and
for each of the one or more timing checks,
designating the first one of the plurality of signals as the clock approximate if the type is a preselected type and the clock approximate is equivalent to either a null value or the second one of the plurality of signals.

18. The one or more tangible computer-readable media recited in claim 17, the preselected type being either a hold type timing check or a setup-hold type timing check.

19. The one or more tangible computer-readable media recited in claim 18, wherein:
one or more of the hardware models include a modeling construct, the one or more modeling constructs describing one or more operations to be performed on data carried by ones of the plurality of signal carriers connected to the respective hardware model; and
the set of operations further comprises identifying one or more additional clock approximates from the plurality of signal carriers based in part upon the one or more modeling constructs.

20. The one or more tangible computer-readable media recited in claim 19, the operation for identifying one or more additional clock approximates from the plurality of signal carriers based in part upon the one or more modeling constructs comprising:
for each of the one or more modeling constructs that describe sequential operations,
identifying ones of the plurality of signal carries connected to the respective hardware model that are edge trigger, and
designating the identified ones of the plurality of signal carriers that are edge triggers and that are not read in during the sequential operations as ones of the one or more additional clock approximates.

21. The one or more tangible computer-readable media recited in claim 20, the set of operations further comprising:
designating the clock approximate and the one or more additional clock approximates as a plurality of potential clock approximates;
implementing a portion of a simulation process on the electronic design; and
identifying the clock approximate from the plurality of potential clock approximates based in part upon the portion of the simulation process.

22. The one or more tangible computer-readable media recited in claim 20, the operation for identifying one or more clock approximates from the plurality of potential clock approximates based in part upon the portion of the simulation process comprising:
identifying the one of the plurality of potential clock approximates that changed state the most highest number of times during the portion of the simulation process; and
designating the identified one of the plurality of potential clock approximates as the clock approximate.

23. One or more tangible computer-readable media, having computer executable instructions determining at least one clock approximate within an electronic design stored thereon, the computer executable instructions comprising:
causing a computer to perform a set of operations; and
wherein the set of operations include:
identifying an electronic design, the electronic design including a plurality of hardware models interconnected by a plurality of signal carriers;
identifying ones of the plurality of signal carriers that are high-fanout;
implementing at least a portion of a simulation process on the electronic design;
identifying one or more clock approximates from the ones of the plurality signal carriers that are high-fanout based in part upon the portion of the simulation process.

24. The one or more tangible computer-readable media recited in claim 23, the operation for identifying one or more clock approximates from the ones of the plurality signal carriers that are high-fanout comprising:
identifying a threshold fanout value; and
designating the ones of the signal carriers that drive a number of the plurality of hardware elements greater than the threshold fanout value as high-fanout.

25. The one or more tangible computer-readable media recited in claim 24, the operation for identifying a threshold fanout value comprising:
deriving the fanout for each of the plurality of signal carriers; and
deriving the average of the derived fanouts; and
designating the threshold value as greater than the derived average but less than the highest the derived fanouts.

26. The one or more tangible computer-readable media recited in claim 25, the operation for implementing at least a portion of a simulation process on the electronic design comprising:
initiating the simulation process;
tracking the frequency with which the plurality of high-fanout signal carriers change state; and
terminating the simulation process.

27. The one or more tangible computer-readable media recited in claim 26, the operation for identifying a clock approximate from the ones of the plurality signal carriers that are high-fanout based in part upon the portion of the simulation process comprising:
identifying the one of the plurality of high-fanout signal carriers that changed state the most number of times during the portion of the simulation process; and
designating the identified one of the plurality of high-fanout signal carriers as the clock approximate.

28. The one or more tangible computer-readable media recited in claim 26, the operation for terminating the simulation process terminates the simulation process when a one of the high-fanout signal carriers has changed state a preselected number of times.

29. The one or more tangible computer-readable media recited in claim 28, wherein the target frequency is 1000.

30. The one or more tangible computer-readable media recited in claim 24, wherein the threshold fanout value is greater than 5.

31. A system for determining one or more clock approximate signals within an electronic design comprising:
a processor;
a memory; and
a plurality of modules, stored on the memory and executable by the processor to achieve a particular result, the plurality of modules include,
a design processing module;
a fanout identification module;
a timing check processing module;
a modeling construct module;
a simulation implementation module; and
a simulation result processing module.
